(19) United States
(12) Patent Application Publication
(10) Pub. No.: US 2016/0261597 A1
(43) Pub. Date: Sep. 8, 2016

(54) RESPONSIVE ACTIONS AND STRATEGIES IN ONLINE REPUTATION MANAGEMENT WITH REPUTATION SHAPING

(71) Applicant: Microsoft Technology Licensing, LLC, Redmond, WA (US)

(72) Inventors: Rajmohan Rajagopalan, Sammamish, WA (US); Michael Stokes, Redmond, WA (US); Carolyn Sparling, Lynnwood, WA (US)

(21) Appl. No.: 14/723,983

(22) Filed: May 28, 2015

Related U.S. Application Data
(60) Provisional application No. 62/129,600, filed on Mar. 6, 2015.

(51) Int. Cl. H04L 29/06; H04L 29/08

(52) U.S. Cl. CPC H04L 63/10; H04L 67/30

(57) ABSTRACT

Responsive actions and strategies in online reputation management with reputation shaping are provided. A service, such as a reputation management service, discovers digital assets associated with a reputation owner hosted by external resources. The reputation management service receives a reputation profile configured by a reputation manager. The reputation profile includes suggestions to shape the online reputation of the reputation owner and credentials to accounts of the reputation owner hosted by the external resources. The digital assets and the reputation profile is matched to the suggested actions. The suggested actions is transmitted to the reputation manager to prompt the reputation manager to select and customize the suggested actions. The reputation management service receives a subset of the suggested actions and performs the subset of the suggested actions to shape the online reputation of the reputation owner.

### CROSS-REFERENCE TO RELATED APPLICATION

This Application claims priority under 35 U.S.C. §119(e) to U.S. Provisional Patent Application Ser. No. 62/129,600 filed on Mar. 6, 2015. The disclosure of the U.S. Provisional Patent Application is hereby incorporated by reference in its entirety.

### BACKGROUND

The proliferation of computerized automation of processes in every aspect of life, data storage and processing have become a major component of networked systems handling social interactions. In such systems, social data is entered, modified, or deleted from a number of sources. Various social data stores from simple tables to complicated databases are maintained and synchronized as new entries or modifications are made by different sources. In addition, variety of services are offered to enable internal and external parties' interactivity with the social data hosted by the data stores. Continued maintenance of a reputation of an online subscriber present significant challenges in management and disposition of the social data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing responsive actions and strategies in online reputation management with reputation shaping. A reputation management service may discover digital assets associated with a reputation owner hosted by external resources. The reputation management service may receive a reputation profile configured by a reputation manager. The reputation profile may include suggestions to shape an online reputation of the reputation owner and credentials to accounts of the reputation owner hosted by the external resources. The digital assets and the reputation profile may be matched to suggested actions with operations to shape the online reputation of the reputation owner. The suggested actions may be transmitted to the reputation manager to prompt the reputation manager to select and customize the suggested actions. The reputation management service may receive a subset of the suggested actions. The subset of the suggested actions may be performed to shape the online reputation of the reputation owner.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of responsive actions and strategies in online reputation management with reputation shaping, according to embodiments;

FIG. 2 illustrates an example of interactions between a reputation management service and external resources to provide responsive actions and strategies in online reputation management with reputation shaping, according to embodiments;

FIG. 3 illustrates an example of a user interface to provide responsive actions and strategies in online reputation management with reputation shaping, according to embodiments;

FIG. 4 illustrates a diagram of a reputation management service that provides responsive actions and strategies in online reputation management with reputation shaping, according to embodiments;

FIG. 5 is a simplified networked environment, where a system according to embodiments may be implemented;

FIG. 6 illustrates a general purpose computing device, which may be configured to provide responsive actions and strategies in online reputation management with reputation shaping, according to embodiments; and

FIG. 7 illustrates a logic flow diagram for a process to provide responsive actions and strategies in online reputation management with reputation shaping, according to embodiments.

### DETAILED DESCRIPTION

As briefly described above, responsive actions and strategies may be provided in online reputation management with reputation shaping. A reputation management service may discover digital assets associated with a reputation owner hosted by external resources. The reputation management service may receive a reputation profile configured by a reputation manager. The reputation profile may include suggestions to shape an online reputation of a reputation owner and credentials to accounts of the reputation owner hosted by the external resources. The digital assets and the reputation profile may be matched to suggested actions with operation to shape the online reputation of the reputation owner. The suggested actions may be transmitted to the reputation manager to prompt the reputation manager to select and customize the suggested actions. A subset of the suggested actions may be received. The subset of the suggested actions may include a customization to shape the online reputation. The subset of the suggested actions may be performed to shape the online reputation of the reputation owner.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments, where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide responsive actions and strategies in online reputation management with reputation shaping. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example embodiments may be found in the following description.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or a non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience is a visual display associated with an application or service through which a user interacts with the application or service. A user action refers to an interaction between a user and the user experience of an application or the user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

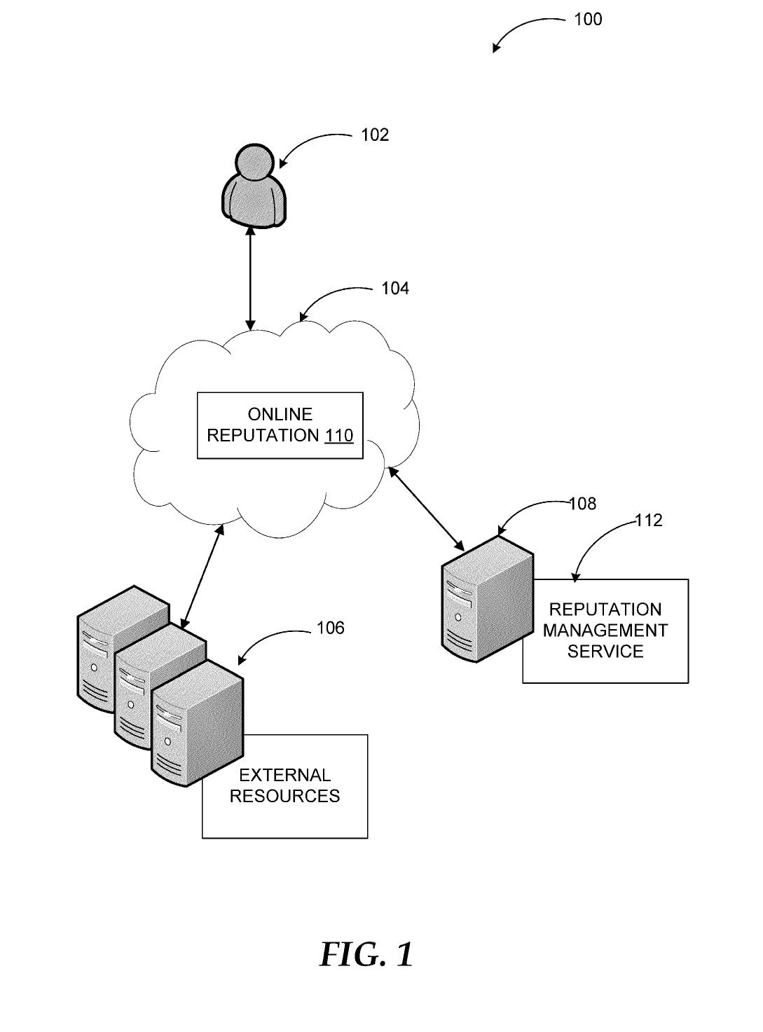

FIG. 1 is a conceptual diagram illustrating an example of responsive actions and strategies in online reputation management with reputation shaping, according to embodiments.

In a diagram 100, a computing device 108 may execute a reputation management service 112. An example of the reputation management service 112 may include a reputation management application that provides information and data processing functionality. The computing device 108 may include a hardware-based server, a laptop computer, a smart phone, a mobile computer, a tablet computer, a vehicle mount computer, a wearable computing device, and a desktop computer, among other similar computing devices. The computing device 108 may communicate with external resources 106 and a client device of a reputation manager 102 through a network 104. The external resources 106 may host digital assets associated with a reputation owner. An online reputation 110 of the reputation owner may be formed from the digital assets hosted by the external resources 106.

The external resources 106 may provide a variety of productivity services. Examples of the productivity services may include communication services, content management services, document management services, online collaboration services, social networking services, professional networking services, application services, and storage services, among others. The storage services may host the digital assets associated with the reputation owner. The application services may provide applications for use and consumption by the client device.

The network 104 may include wired components and wireless components that allow wired communication and wireless communication between nodes, such as the external resources 106, the computing device 108, and a client device of the reputation manager 102, among others. The client device of the reputation manger 102 may display a client user interface (UI) of the reputation management service 112 to the reputation manager 102. The client UI may provide functionality to manage the online reputation 110.

A search may be executed to discover digital assets hosted by the external resources 106. The search may utilize identification information of the reputation owner, which may be stored within a reputation profile of the reputation owner. The digital assets may include pictures, documents, accounts, videos, and account information of the reputation owner, among others. The digital assets may include third-party content of the external resources 106.

The reputation manager 102 may be allowed to interact with the client UI through an input device or a touch-enabled display component of the client device. The client device may include a display device, such as the touch-enabled display component and a monitor, among others. The display device may be used to provide the client UI of the reputation management service 112 to the reputation manager 102. The reputation manager 102 may interact with the client UI with a keyboard-based input, a mouse-based input, a voice-based input, an eye-tracking input, a gyroscopic input, a pen-based input, and a gesture-based input, among others. The gesture-based input may include one or more touch-based actions, such as a touch action, a swipe action, and a combination of each, among others.

The reputation management service 112 may receive the reputation profile from the reputation manager 102. The reputation profile may include suggestions to shape the online reputation 110 of the reputation owner. The digital assets and the reputation profile may be matched to suggested actions, which may be transmitted to the reputation manager 102. A subset of the suggested actions (that include a customization) may be received from the reputation manager 102. The subset of the suggested actions may be performed to shape the online reputation of the reputation owner.

While the example system in FIG. 1 has been described with specific components, including the computing device 108 and the reputation management service 112, embodiments are not limited to these components or system configurations and can be implemented with other system configuration employing fewer or additional components.

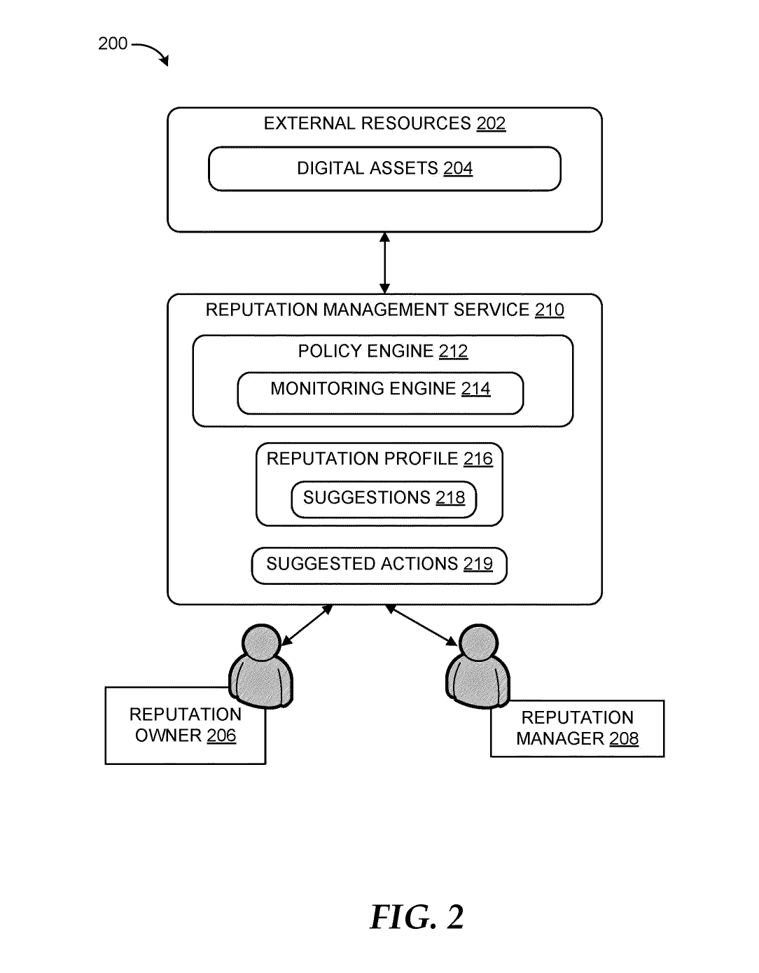

FIG. 2 illustrates an example of interactions between a reputation management service and external resources to provide responsive actions and strategies in online reputation management with reputation shaping, according to embodiments.

In a diagram 200, a reputation management service 210 may interact with external resources 202 to provide responsive actions and strategies in online reputation management with reputation shaping. Digital assets 204 associated with a reputation owner 206 may be hosted on the external resources 202. The digital assets 204 may form an online reputation of the reputation owner 206. The digital assets 204 may include pictures, documents, accounts, videos, and account information of the reputation owner 206, among others. In an example scenario, the digital assets 204 may be owned by the reputation owner 206. Alternatively, third-party content (hosted by the external resources 202) may be identified as the digital assets 204. The third-party content may identify the reputation owner 206. The digital assets 204, third party content, and other digital assets hosted by other external resources may form the online reputation of the reputation owner 206.

The reputation management service 210 may include components, such as a policy engine 212 and a monitoring engine 214. The policy engine 212 and the monitoring engine 214 may be stand-alone components of the reputation management service 210. The monitoring engine 214 may also be a component of the policy engine 212.

The monitoring engine 214 may also search accounts of the reputation owner 206 in the external resources 202 to locate the digital assets 204. In an example scenario, the monitoring engine 214 may use machine learning techniques to monitor the digital assets 204, textual content interpretation to process the third-party content of the digital assets 204, and image recognition to detect the digital assets 204.

The monitoring engine 214 may also use identification information of the reputation owner 206 within the reputation profile to search for the digital assets 204. The monitoring engine 214 may discover usage information associated with the reputation owner 206 and the external resources 202. The usage information may include search terms used by the reputation owner 206 to locate the digital assets 204 in the external resources 202, among others. The usage information may be identified as the digital assets 204.

The policy engine 212 may authenticate the reputation manager 208 through a client user interface (UI) of the reputation management service 210 displayed on a client device. The reputation manager 208 may include the reputation owner 206, an authorized public relation firm of the reputation owner 206, an authorized business associated with the reputation owner 206, an authorized landlord of the reputation owner 206, an authorized school associated with the reputation owner 206, an authorized non-governmental agency associated with the reputation owner 206, an authorized government agency associated with the reputation owner 206, a legal representative of the reputation owner 206, an authorized family member of the reputation owner 206, a legal relationship of the reputation owner 206, an authorized relation of the reputation owner 206, an authorized colleague of the reputation owner 206, and/or an authorized supervisor of the reputation owner 206, among others. For example, the reputation manager 208 (e.g. a parent) may be the legal relationship of the reputation owner 206, where the reputation owner 206 is a child.

Controls may be displayed on the client UI of the reputation management service to allow the reputation manager 208 to configure a reputation profile 216 of the reputation owner 206. The reputation profile may include suggestions 218 that form reputation goals of the reputation owner 206. The reputation goals may include, among others, applying for a job, applying to rent an apartment, selling a product in a geographic location, and/or removing negative content on the external resources 202.

The policy engine 212 may match the reputation profile 216 and the digital assets 204 to the suggested actions 219. The suggested actions 219 may include a closure of one or more accounts (that store the digital assets 204) of the reputation owner 206, a deletion of an identification information of the reputation owner 206 from the digital assets 204, a creation of a new account of the reputation owner 206 at the external resources 202, a deletion of the digital assets 204 in response to an inactivity of the reputation owner 206 to access the digital assets 204, or a modification of the digital assets 204 of the reputation owner 206.

In an example scenario, the suggested actions may be part of a comprehensive strategy to shape the online reputation of the reputation owner 206 through suppression of a subset of the digital assets 204 or a promotion of another subset of the digital assets 204. A reputation goal may include applying for a position in a political organization. Depending on the views of the political organization, the subset of the digital assets 204 may be undesirable to the organization. The reputation management service 210 may transmit the undesirable digital assets to the reputation manger 208 for review. Additionally, the reputation management service 210 may provide suggested actions to proactively shape the online reputation to match the reputation goals of the reputation owner 206.

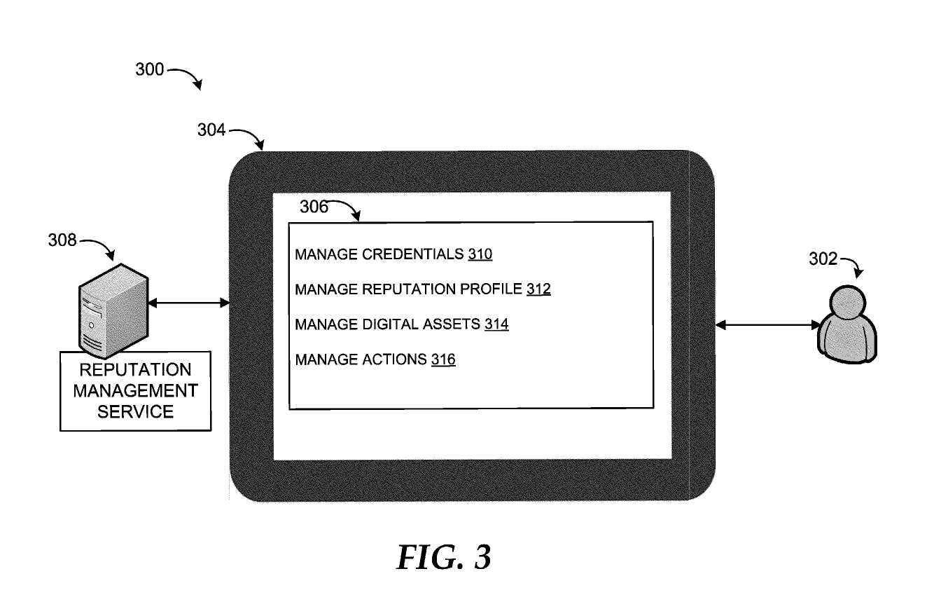

FIG. 3 illustrates an example of a user interface to provide responsive actions and strategies in online reputation management with reputation shaping, according to embodiments.

In a diagram 300, a reputation management service 308 may provide a client user interface (UI) 306 on a computing device 304 to allow a reputation manager 302 to customize reputation shaping actions. The reputation manager 302 may manage the reputation shaping actions by selecting or customizing selected actions, digital assets, or a reputation profile of a reputation owner.

The client UI 306 may display a “manage credentials” control 310. In response to an activation of the “manage credentials” control 310, the client UI 306 may display additional controls to capture credentials of the reputation manager 302 or authenticate the credentials of the reputation manager 302. The reputation manager 302 may be authenticated after receiving legal documentation to verify the relationship between the reputation manager 302 and the reputation owner. The reputation manager 302 may also be authenticated automatically based on a location of access to the reputation management service 308, a type of the computing device 304 used by the reputation manager 302 to access the reputation management service 308, or an application used by the reputation manager 302 to access the reputation management service 308, among others.

The client UI 306 may display a “manage reputation profile” control 312 to provide the reputation manager 302 with additional controls to modify the reputation profile of the reputation owner. The reputation manager 302 may be provided with the additional controls to modify suggestions that form reputation goals of the reputation owner. The reputation manager 302 may also be allowed to configure credentials of the reputation owner stored in the reputation profile. The credentials of the reputation owner may be used to access accounts that store the digital assets associated with the reputation owner. The reputation manager 302 may have restricted access to the credentials of the reputation owner based on authorization level granted to the reputation manager 302 by the reputation owner.

The client UI 306 may display a “manage digital assets” control 314 to provide the reputation manager 302 with additional controls to modify a list of digital assets or select a subset of the digital assets associated with the reputation owner. The subset of the digital assets may be managed to shape the online profile of the reputation owner.

The client UI 306 may display a “manage actions” control 316 (upon activation) to provide additional controls to select and modify suggested actions that include operations to proactively shape online reputation of the reputation owner. The reputation manager 302 may be provided with a set of default reputation shaping actions. The reputation manager 302 may be allowed to select from and customize the set of default reputation shaping actions to form the suggested actions.

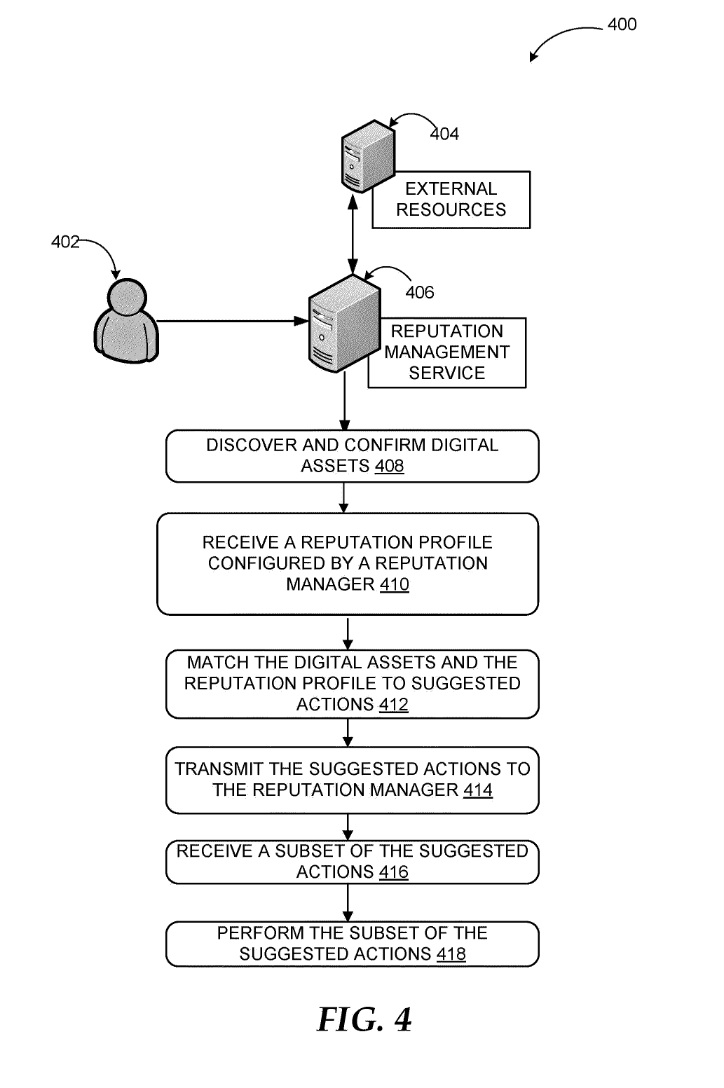

FIG. 4 illustrates a diagram of a reputation management service that provides responsive actions and strategies in online reputation management with reputation shaping, according to embodiments.

In a diagram 400, a reputation management service 406 may interact with a reputation manager 402 through a client user interface (UI) of the reputation management service 406 displayed on a client device. The reputation management service 406 may execute a search to discover and confirm 408 digital assets hosted by external resources 404. The search may utilize identification information of the reputation owner (stored in a reputation profile) to detect the digital assets or third party content (that identify the reputation owner) hosted by the external resources 404.

In some examples, the reputation management service 406 may analyze the digital assets to identify predictive information or a reputation forecast of the online reputation. The predictive information (or the reputation forecast) may include future trends associated with the digital assets of the reputation owner. The reputation forecast may allow the reputation manger 402 to shape the online reputation of the reputation owner based on the future trends.

The reputation management service 406 may analyze the digital assets to identify usage data. The usage data may be collected by service providers, which may form an inaccurate picture of the reputation owner. The usage data may be based on websites visited by the reputation owner, services used by the reputation owner, products viewed by the reputation owner, terms entered into a search engine by the reputation owner, or subscriptions to online accounts of the reputation owner, among others. The usage data may be identified as the digital assets and matched to suggested actions to shape the online profile of the reputation owner by managing the usage data.

In further examples, the reputation management service 406 may identify inconsistencies within the digital assets and/or within the third-party content of the digital assets. For example, the inconsistencies may include duplicates of the digital assets, usage data duplicates, the digital assets containing an incorrect identification of the reputation owner, or the usage data containing the incorrect identification of the reputation owner.

The reputation management service 406 may also identify inconsistencies between digital assets and third-party content that identify the reputation owner. In an example, the reputation management service 406 may notify the reputation manager 402 about the inconsistencies to prompt the reputation manager 402 to proactively shape the online reputation of the reputation owner.

The reputation management service 406 may receive the reputation profile 410 configured by the reputation manager 402. The reputation profile and the digital assets may be matched 412 to the suggested actions. Suggestions within the reputation profile and attributes of the digital assets may be matched to suggested actions with operations to shape the online reputation of the reputation owner. The attributes may include a type of the content of the digital assets, identifiers associated with the content, among others.

The reputation management service 406 may receive 416 a subset of the suggested actions. The subset of the suggested actions may include a customization to the suggested actions transmitted (414) to the reputation manager 402. The reputation management service 406 may perform 418 the subset of the suggested actions to shape the online reputation. A notification may also be transmitted to the reputation manager 402 to inform the reputation manager 402 of a completed performance of the subset of the suggested actions. The notification may include, among others, an audio notification, a video notification, a textual notification, and/or a vibration notification.

Embodiments address a need that arises from very large scale of operations created by networked computing and cloud-based services that cannot be managed by humans. The actions/operations described herein are not a mere use of a computer, but address results of a system that is a direct consequence of software used as a service, such as the reputation management service 406 configured to provide responsive actions and strategies in online reputation management with reputation shaping. The actions may improve privacy of the reputation owner, improve the online reputation of the reputation owner, improve user efficiency associated with the online reputation, and/or improve user interaction performance of the online reputation.

The examples provided in FIG. 1 through FIG. 4 are illustrated with specific services, modules, and user experience configurations. Embodiments are not limited to environments according to these examples. Providing responsive actions and strategies in online reputation management with reputation shaping may be implemented in environments employing fewer or additional services, modules, and user experience configurations. Furthermore, the example services, modules, and user experience configurations shown in FIG. 1 through FIG. 4 may be implemented in a similar manner with other values using the principles described herein.

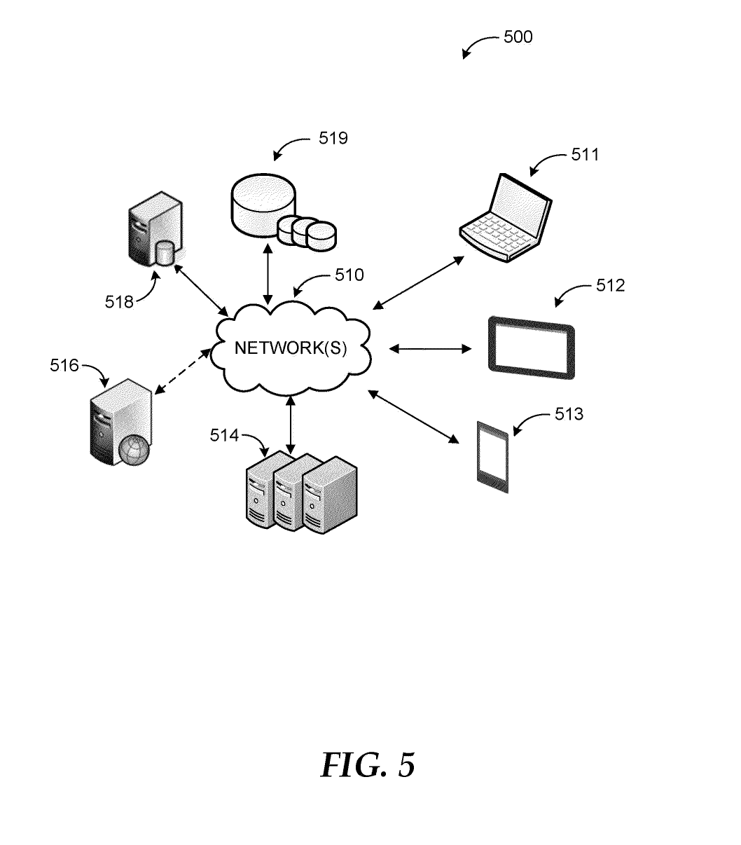

FIG. 5 illustrates an example networked environment, where a system according to embodiments may be implemented.

A reputation management service configured to provide responsive actions and strategies in online reputation management with reputation shaping may be implemented via software executed over one or more servers 514 such as a hosted service. The platform may communicate with client applications on individual computing devices, such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. For example, responsive actions and strategies in online reputation management with reputation shaping may be provided. A reputation management service may discover digital assets associated with a reputation owner hosted by external resources. The reputation management service may receive a reputation profile configured by a reputation manager. The reputation profile may include suggestions to shape an online reputation of the reputation owner and credentials to accounts of the reputation owner hosted by the external resources. The digital assets and the reputation profile may be matched to suggested actions with operations to shape the online reputation of the reputation owner. The reputation profile and the suggested actions may be stored in data store(s) 519 directly or through a database server 518. The suggested actions may be transmitted to the reputation manager to prompt the reputation manager to select and customize the suggested actions. The reputation management service may receive a subset of the suggested actions and may perform the subset of the suggested actions to shape the online reputation of the reputation owner.

The network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide responsive actions and strategies in online reputation management with reputation shaping. Furthermore, the networked environments discussed in FIG. 5 are for illustration purposes only. Embodiments are not limited to the example applications, modules, or processes.

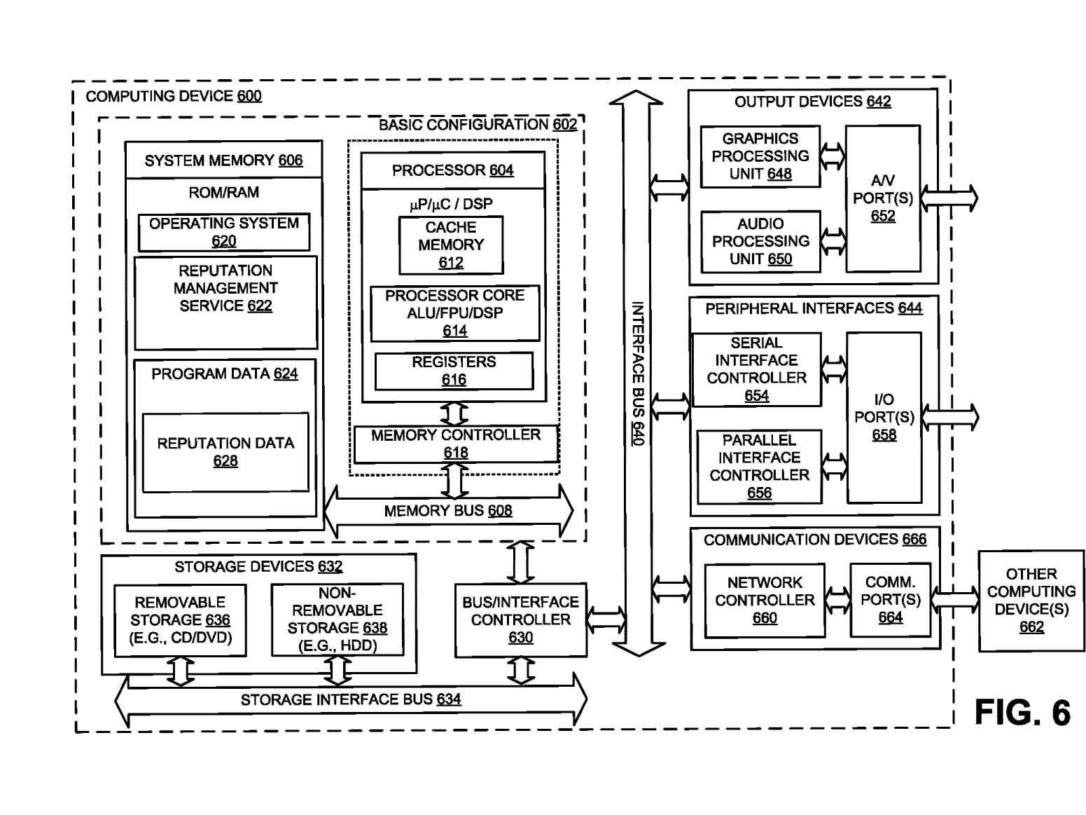

FIG. 6 illustrates a general purpose computing device, which may be configured to provide responsive actions and strategies in online reputation management with reputation shaping, according to at least some embodiments disclosed herein.

For example, a computing device 600 may be used as a server, a desktop computer, a portable computer, a smart phone, a special purpose computer, or a similar device. In a basic configuration 602, the computing device 600 may include one or more processors 604 and a system memory 606 A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, processor cores 614, and registers 616. The processor cores 614 may (each) include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof The system memory 606 may include an operating system 620, a reputation management service 622, and program data 624. The reputation management service 622 may include a policy engine and a monitoring engine. The reputation management service may discover digital assets associated with a reputation owner hosted by external resources. The reputation management service may receive a reputation profile configured by a reputation manager. The reputation profile may include suggestions to shape an online reputation of the reputation owner and credentials to accounts of the reputation owner hosted by the external resources. The digital assets and the reputation profile may be matched to suggested actions with operations to shape the online reputation of the reputation owner. The suggested actions may be transmitted to the reputation manager to prompt the reputation manager to select and customize the suggested actions. The reputation management service may receive a subset of the suggested actions and may perform the subset of the suggested actions to shape the online reputation of the reputation owner.

In some examples, the reputation management service 622 may be a reputation management application. Components of the reputation management application (such as a client user interface) may also be displayed on a display device. An example of the display device may include another computing device with a display component. The display device may include a touch-based device that detects gestures such as a touch action. The display device may also, provide feedback in response to detected gestures (or any other form of input) by transforming a client user interface of the reputation management service 622, displayed by the touch based device. The program data 624 may also include, among other data, reputation data 628, as described herein. The reputation data 628 may include a reputation profile, a digital asset, and a suggested action, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, output devices 642, peripheral interfaces 644, and communication devices 646) to the basic configuration 602 via the bus/interface controller 630. Some of the output devices 642 include a graphics processing unit 648 and an audio processing unit 650, which may be configured to communicate to various external devices such as a display or speakers via one or more AIV ports 652. The peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more 110 ports 658. One of the communication devices 646 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods to provide responsive actions and strategies in online reputation management with reputation shaping. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

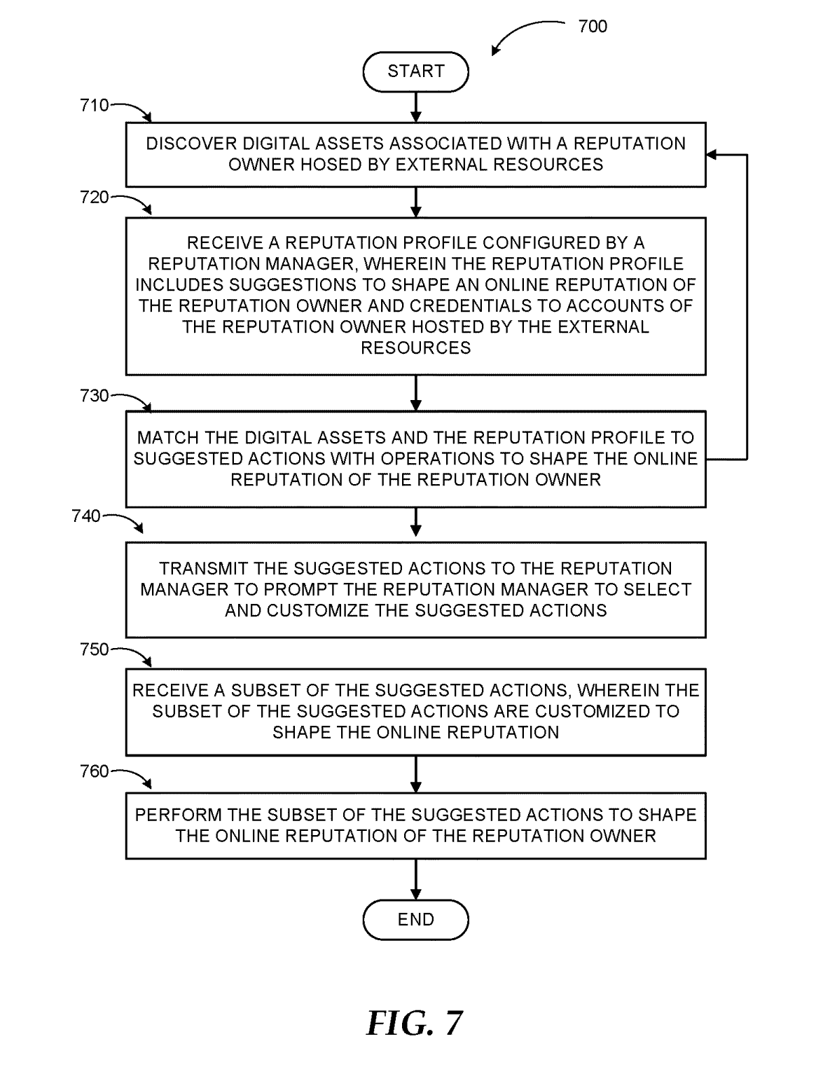

FIG. 7 illustrates a logic flow diagram for a process to provide responsive actions and strategies in online reputation management with reputation shaping, according to embodiments.

Process 700 begins with operation 710, where a reputation management service may discover digital assets associated with a reputation owner hosted by external resources. At operation 720, the reputation management service may receive a reputation profile configured by the reputation manager. The reputation profile may include suggestions to shape an online reputation of a reputation owner. At operation 730, the reputation management service may match the digital assets and the reputation profile to suggested actions with operations to shape the online reputation of the reputation owner.

The reputation management service may transmit the suggested actions to the reputation manger to prompt the reputation manger to select and customize the suggested actions, at operation 740. At operation 750, the reputation management service may receive a subset of the suggested actions. The subset of the suggested actions may be customized to shape the online reputation. At operation 760, the reputation management service may perform the subset of the suggested actions to shape the online reputation of the reputation owner. The reputation management service may transmit a notification to the reputation manager to inform the reputation manager of a completed performance of the subset of the suggested actions.

Some or all of the operations of the process 700 may be reprocessed with feedback operations. In an example scenario, the suggested actions that are matched from the digital assets in the operation 730 may be used as an input in the operation 710 to discover related digital assets. The related digital assets may include the attributes associated with the suggested actions. Other feedback loops may be used with other operations of the process 700 to customize operations of the process 700, among other things.

The operations included in process 700 are for illustration purposes. A management service according to embodiments may be implemented by similar processes with fewer or additional steps, as well as in different order of operations using the principles described herein.

According to some examples a computing device to provide responsive actions and strategies in online reputation management with reputation shaping is described. The computing device may include a memory configured to store instructions associated with a reputation management service and one or more processors coupled to the memory. The one or more processors may execute the management service in conjunction with instructions stored in the memory. The reputation management service may include a monitoring engine configured to discover digital assets associated with a reputation owner hosted by external resources. The reputation management service may also include a policy engine configured to receive a reputation profile configured by a reputation manager, where the reputation profile includes one or more suggestions to shape an online reputation of the reputation owner and credentials to accounts of the reputation owner hosted by the external resources, match the digital assets and the reputation profile to suggested actions associated with operations to shape the online reputation of the reputation owner, transmit the suggested actions to the reputation manager to prompt the reputation manager to select and customize the suggested actions, receive a subset of the suggested actions, where the subset of the suggested actions include a customization to shape the online reputation, and perform the subset of the suggested actions to shape the online reputation of the reputation owner.

According to other examples, the reputation manager may include one or more of the reputation owner, an authorized public relation firm of the reputation owner, an authorized business of the reputation owner, an authorized landlord of the reputation owner, an authorized school associated with the reputation owner, an authorized non-governmental agency associated with the reputation owner, an authorized government agency associated with the reputation owner, a legal representative of the reputation owner, an authorized family member of the reputation owner, an authorized relation of the reputation owner, an authorized colleague of the reputation owner, and an authorized supervisor of the reputation owner.

According to further examples, the monitoring engine is further configured to search the accounts of the reputation owner to locate the digital assets. The policy engine is further configured to process the digital assets and the reputation profile to match the suggested actions associated with the operations to shape the online reputation of the reputation owner. The monitoring is further configured to use one or more of: machine learning techniques to monitor the digital assets, textual content interpretation to process content of the digital assets, and image recognition to identify the digital assets. The monitoring engine is further configured to search the external resources using identification information of the reputation owner within the reputation profile for third-party content, where the third-party content identifies the reputation owner. The policy engine is further configured to process the third-party content and the reputation profile to match the suggested actions with the operations to shape the online reputation of the reputation owner.

According to other examples, the policy engine is further configured to transmit an authentication request to the reputation owner to prompt the reputation owner to authorize the reputation manager to shape the reputation profile of the reputation owner, receive an authorization from the reputation owner that allows the reputation manager to shape the reputation profile of the reputation owner, and grant the authorization to the reputation manager. The policy engine is further configured to analyze the digital assets to identify predictive information, where the predictive information includes future trends associated with the reputation owner, match the predictive information and the reputation profile to the suggested actions to shape the reputation profile of the reputation owner, and transmit a report on the predictive information and the suggested actions to the reputation manager to prompt the reputation manager to select and customize the suggested actions.

The policy engine is further configured to identify one or more inconsistencies within the digital assets, where the one or more inconsistencies include one or more of: duplicates of the digital assets, usage data duplicates, the digital assets containing incorrect identification information of the reputation owner, and the usage data containing the incorrect identification information of the reputation owner. The policy engine is further configured to match the one or more inconsistencies and the reputation profile to the suggested actions to shape the reputation profile of the reputation and transmit a report on the one or more inconsistencies and the suggested actions to the reputation manager to prompt the reputation manager to select and customize the suggested actions.

According to some examples, a method executed on a computing device to provide responsive actions and strategies in online reputation management with reputation shaping is described. The method may include discovering digital assets associated with a reputation owner hosted by external resources, receiving a reputation profile configured by a reputation manager, where the reputation profile includes suggestions to shape an online reputation of the reputation owner and credentials to accounts of the reputation owner hosted by the external resources, matching the digital assets and the reputation profile to suggested actions associated with operations to shape the online reputation of the reputation owner, transmitting the suggested actions to the reputation manager to prompt the reputation manager to select and customize the suggested actions, where the reputation manager includes one or more of the reputation owner, a public relation firm, a business, a landlord, a school, a non-governmental agency, and a government agency, receiving a subset of the suggested actions, where the subset of the suggested actions are customized to shape the online reputation, and performing the subset of the suggested actions to shape the online reputation of the reputation owner.

According to other examples, the method may further include identifying usage data associated with the digital assets of the reputation owner within the external resources, where the usage data is based on one or more of: websites visited by the reputation owner, services used by the reputation owner, products viewed by the reputation owner, terms entered into a search engine by the reputation owner, and subscriptions to online accounts, matching the usage data and the reputation profile to the suggested actions to shape the reputation profile of the reputation, and transmitting a report on the usage data and the suggested actions to the reputation manager to prompt the reputation manager to select and customize the suggested actions.

According to further examples, the suggested actions include one or more of: a closure of one or more accounts of the reputation owner on the external resources, where the one or more accounts store the digital assets, a deletion of identification information of the reputation owner from the digital assets, a creation of a new account of the reputation owner at the external resources, a deletion of the digital assets in response to an inactivity of the reputation owner to access the digital assets, and a modification of the digital assets of the reputation owner. The method may further include transmitting a notification to the reputation manager to inform the reputation manager of a completed performance of the subset of the suggested actions.

According to some examples, a computer-readable memory device with instructions stored thereon to provide responsive actions and strategies in online reputation management with reputation shaping is described. The instructions may include actions that are similar to the method described above.

According to some examples a means to provide responsive actions and strategies in online reputation management with reputation shaping is described. The means to provide responsive actions and strategies in online reputation management with reputation shaping may include a means to discover digital assets associated with a reputation owner hosted by external resources, a means to receive a reputation profile configured by a reputation manager, where the reputation profile includes one or more suggestions to shape an online reputation of the reputation owner and credentials to accounts of the reputation owner hosted by the external resources, a means to match the digital assets and the reputation profile to suggested actions associated with operations to shape the online reputation of the reputation owner, a means to transmit the suggested actions to the reputation manager to prompt the reputation manager to select and customize the suggested actions, a means to receive a subset of the suggested actions, where the subset of the suggested actions include a customization to shape the online reputation, and a means to perform the subset of the suggested actions to shape the online reputation of the reputation owner.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide responsive actions and strategies in online reputation management with reputation shaping, the computing device comprising:
a display device;
a memory configured to store instructions associated with a reputation management service;
one or more processors coupled to the memory and the display device, the one or more processors executing the reputation management service in conjunction with instructions stored in the memory, wherein the reputation management service includes:
a monitoring engine configured to:
discover digital assets associated with a reputation owner hosted by external resources;
a policy engine configured to:
receive a reputation profile configured by a reputation manager, wherein the reputation profile includes one or more suggestions to shape an online reputation of the reputation owner and credentials to accounts of the reputation owner hosted by the external resources;
match the digital assets and the reputation profile to suggested actions associated with operations to shape the online reputation of the reputation owner;
transmit the suggested actions to the reputation manager to prompt the reputation manager to select and customize the suggested actions;
receive a subset of the suggested actions, wherein the subset of the suggested actions include a customization to shape the online reputation; and
perform the subset of the suggested actions to shape the online reputation of the reputation owner.

2. The computing device of claim 1, wherein the reputation manager includes one or more of the reputation owner, an authorized public relation firm of the reputation owner, an authorized business of the reputation owner, an authorized landlord of the reputation owner, an authorized school associated with the reputation owner, an authorized non-governmental agency associated with the reputation owner, an authorized government agency associated with the reputation owner, a legal representative of the reputation owner, an authorized family member of the reputation owner, an authorized relation of the reputation owner, an authorized colleague of the reputation owner, and an authorized supervisor of the reputation owner.

3. The computing device of claim 1, wherein the monitoring engine is further configured to:
search the accounts of the reputation owner to locate the digital assets.

4. The computing device of claim 3, wherein the policy engine is further configured to:
process the digital assets and the reputation profile to match the suggested actions associated with the operations to shape the online reputation of the reputation owner.

5. The computing device of claim 1, wherein the monitoring engine is further configured to:
use one or more of: machine learning techniques to monitor the digital assets, textual content interpretation to process content of the digital assets, and image recognition to identify the digital assets.

6. The computing device of claim 1, wherein the monitoring engine is further configured to:
search the external resources using identification information of the reputation owner within the reputation profile for third-party content, wherein the third-party content identifies the reputation owner.

7. The computing device of claim 6, wherein the policy engine is further configured to:
process the third-party content and the reputation profile to match the suggested actions with the operations to shape the online reputation of the reputation owner.

8. The computing device of claim 1, wherein the policy engine is further configured to:
transmit an authentication request to the reputation owner to prompt the reputation owner to authorize the reputation manager to shape the reputation profile of the reputation owner;
receive an authorization from the reputation owner that allows the reputation manager to shape the reputation profile of the reputation owner; and
grant the authorization to the reputation manager.

9. The computing device of claim 1, wherein the policy engine is further configured to:
analyze the digital assets to identify predictive information, wherein the predictive information includes future trends associated with the reputation owner.

10. The computing device of claim 9, wherein the policy engine is further configured to:
match the predictive information and the reputation profile to the suggested actions to shape the reputation profile of the reputation owner; and
transmit a report on the predictive information and the suggested actions to the reputation manager to prompt the reputation manager to select and customize the suggested actions.

11. The computing device of claim 1, wherein the policy engine is further configured to:
identify one or more inconsistencies within the digital assets, wherein the one or more inconsistencies include one or more of: duplicates of the digital assets, usage data duplicates, the digital assets containing incorrect identification information of the reputation owner, and the usage data containing the incorrect identification information of the reputation owner.

12. The computing device of claim 11, wherein the policy engine is further configured to:
match the one or more inconsistencies and the reputation profile to the suggested actions to shape the reputation profile of the reputation; and
transmit a report on the one or more inconsistencies and the suggested actions to the reputation manager to prompt the reputation manager to select and customize the suggested actions.

13. A method executed on a computing device to provide responsive actions and strategies in online reputation management with reputation shaping, the method comprising:
discovering digital assets associated with a reputation owner hosted by external resources;
receiving a reputation profile configured by a reputation manager, wherein the reputation profile includes suggestions to shape an online reputation of the reputation owner and credentials to accounts of the reputation owner hosted by the external resources;
matching the digital assets and the reputation profile to suggested actions associated with operations to shape the online reputation of the reputation owner;
transmitting the suggested actions to the reputation manager to prompt the reputation manager to select and customize the suggested actions, wherein the reputation manager includes one or more of the reputation owner, a public relation firm, a business, a landlord, a school, a non-governmental agency, and a government agency;
receiving a subset of the suggested actions, wherein the subset of the suggested actions are customized to shape the online reputation; and
performing the subset of the suggested actions to shape the online reputation of the reputation owner.

14. The method of claim 13, further comprising:
identifying usage data associated with the digital assets of the reputation owner within the external resources, wherein the usage data is based on one or more of: websites visited by the reputation owner, services used by the reputation owner, products viewed by the reputation owner, terms entered into a search engine by the reputation owner, and subscriptions to online accounts.

15. The method of claim 14, further comprising:
matching the usage data and the reputation profile to the suggested actions to shape the reputation profile of the reputation; and
transmitting a report on the usage data and the suggested actions to the reputation manager to prompt the reputation manager to select and customize the suggested actions.

16. The method of claim 13, wherein the suggested actions include one or more of:
a closure of one or more accounts of the reputation owner on the external resources, wherein the one or more accounts store the digital assets,
a deletion of identification information of the reputation owner from the digital assets,
a creation of a new account of the reputation owner at the external resources,
a deletion of the digital assets in response to an inactivity of the reputation owner to access the digital assets, and
a modification of the digital assets of the reputation owner.

17. The method of claim 13, further comprising:
transmitting a notification to the reputation manager to inform the reputation manager of a completed performance of the subset of the suggested actions.

18. A computer-readable memory device with instructions stored thereon to provide responsive actions and strategies in online reputation management with reputation shaping, the instructions comprising:
discovering digital assets associated with a reputation owner hosted by external resources;
receiving a reputation profile configured by a reputation manager, wherein the reputation profile includes suggestions to shape an online reputation of the reputation owner and credentials to accounts of the reputation owner hosted by the external resources;
matching the digital assets and the reputation profile to suggested actions with operations to shape the online reputation of the reputation owner;
transmitting the suggested actions to the reputation manager to prompt the reputation manager to select and customize the suggested actions, wherein the reputation manager includes one or more of the reputation owner, a public relation firm, a business, a landlord, a school, a non-governmental agency, and a government agency;
receiving a subset of the suggested actions, wherein the subset of the suggested actions are customized to shape the online reputation; and
performing the subset of the suggested actions to shape the online reputation of the reputation owner.

19. The computer-readable memory device of claim 18, wherein the instructions further comprise:
identifying one or more inconsistencies within the digital assets, wherein the one or more inconsistencies include one or more of: duplicates of the digital assets, usage data duplicates, the digital assets containing incorrect identification information of the reputation owner, and the usage data containing the incorrect identification information of the reputation owner;
matching the one or more inconsistencies and the reputation profile to the suggested actions to shape the reputation profile of the reputation; and
transmitting a report on the one or more inconsistencies and the suggested actions to the reputation manager to prompt the reputation manager to select and customize the suggested actions.

20. The computer-readable memory device of claim 18, wherein the instructions further comprise:
analyzing the digital assets to identify predictive information, wherein the predictive information includes future trends associated with the reputation owner;
matching the predictive information and the reputation profile to suggested actions to shape the reputation profile of the reputation owner; and
transmitting a report on the predictive information and the suggested actions to the reputation manager to prompt the reputation manager to select and customize the suggested actions.
